(19) United States
(12) Patent Application Publication
(10) Pub. No.: US 2002/0088697 A1
(43) Pub. Date: Jul. 11, 2002

(54) Illuminated keyboard keys

(76) Inventor: Curt E. Stephens, New Berlin, IL (US)

Correspondence Address: Joseph H. McGlynn, 6111 Saddle Horn Dr., Fairfax, VA, 22030, US

(21) Appl. No.: 09/755,062

(22) Filed: Jan. 8, 2001

(51) Int. Cl. H01H 9/18

(52) U.S. Cl. 200/314

(57) ABSTRACT

An illuminated keyboard made of a housing used to mount keys with each key having a key cap. Each of the key caps have indicia designation whose material is made of transparent material. Surrounding the material of the key cap is opaque material. Within the keyboard housing is a light source to shine light through the indicia designated transparent material. The housing material on the facing front which displays the key caps may also be made of an opaque material to concentrate the emitted light from within the housing through the indicia designations of the key caps.

### BACKGROUND OF THE INVENTION

This invention relates to an illuminated keyboard wherein the keyboard has a plurality of separated keys and each individual key has a single alphanumeric designation and an illumination source for each key.

A standard keyboard such as found on a typewriter or computer keyboard is composed of rows of letters and numbers. Typically, a conventional computer keyboard also has a row of keys designating specific functions by the letters F1 to F12. A separate key pad composed of rows and columns may have numbers and additional keys may be used to move a cursor up, down, to the left or right. Further keys designating specific functions are also commonly found on a conventional keyboard of a computer.

When using such a conventional keyboard it may be difficult to discern the specific indicia on an individual key due to low light conditions or a user's visual impairment requiring more ambient light than is normally available. To provide more illuminate to the keys light sources have been used. For example, in one earlier invention an illuminated keyboard allows light to shine through the entire area of the key caps.

In another earlier related invention, a keyboard has a plurality of keys which are individually inserted on the keyboard to permit a variable inclination of the key plane.

Another prior art illuminated keyboard allows light to shine through the entire area of the key caps.

One other invention has an elongated electroluminescent strip that extends through openings and beneath a panel to illuminate the legends on a column of keys.

Still another invention discloses an illuminated keyboard which allows light to shine through the entire area of the key caps.

### DESCRIPTION OF THE PRIOR ART

Keyboards that are illuminated by light sources or have other characteristics to distinguish the individual keys from each other are known. For example, U.S. Pat. No. 4,449,024 to Stracener discloses an illuminated keyboard allows light to shine through the entire area of the key caps.

U.S. Pat. No. 4,563,550 to Bertina discloses a keyboard that has a plurality of keys which are individually inserted on the keyboard to permit a variable inclination of the key plane.

U.S. Pat. No. 4,772,769 to Shumate discloses an illuminated keyboard which allows light to shine through the entire area of the key caps.

U.S. Pat. No. 4,806,908 to Krupnik discloses an elongated electroluminescent strip that extends through openings and beneath a panel to illuminate the legends on a column of keys.

U.S. Pat. No. 5,266,949 to Rossi discloses an illuminated keyboard which allows light to shine through the entire area of the key caps.

In the present invention a keyboard with transparent alphanumeric designations with one designation for each separate key cap has an opaque surrounding on the key cap to prevent an underlining light source from shining through the key cap except at the transparent designation all as will be detailed in the specification that follows hereafter.

### SUMMARY OF THE INVENTION

This invention relates to a keyboard having conventional designations for each key cap wherein the material making up the designation is transparent and the surrounding material of the key cap is opaque to permit light from an underlying light source to shine through the designated transparent material.

It is the primary object of the present invention to provide for an improved illuminated alphanumeric keyboard.

Another object is to provide for such a keyboard wherein the individual key caps are composed of specific designated indicia made of a transparent material while the surrounding material in the key cap around the designation is made of an opaque material.

These and other objects and advantages of the present invention will become apparent to readers from a consideration of the ensuing description and the accompanying drawings.

### BRIEF DESCRIPTION OF THE DRAWINGS

FIG. 1 is a perspective view of the present invention.

FIG. 2 is a perspective view of the underlying light source panel used with the keyboard of FIG. 1.

FIG. 3 is an enlarged perspective view of a typical key cap schematically illustrating the transparent designation of that key cap and the surrounding material and light source.

### DESCRIPTION OF THE PREFERRED EMBODIMENT

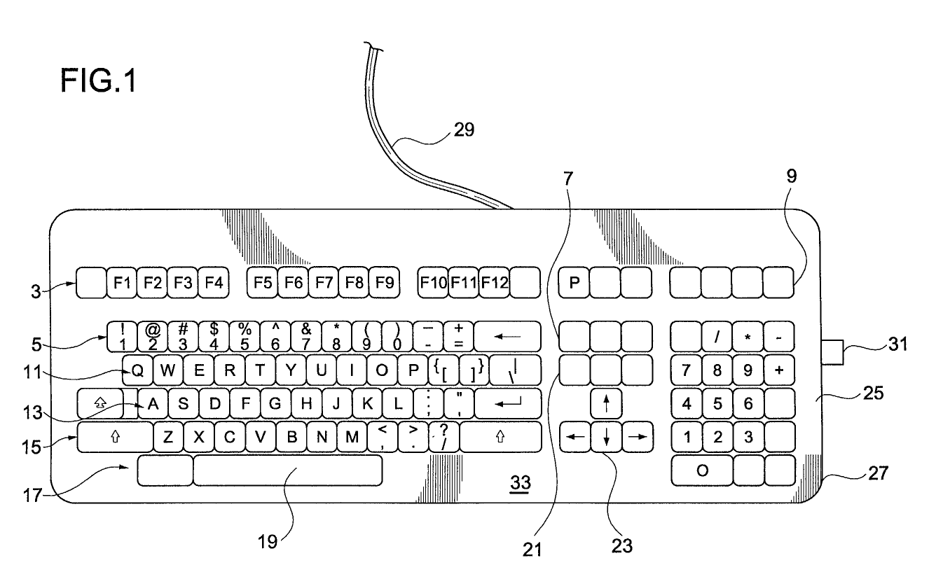

FIG. 1 is a perspective view of the present invention as embodied in a conventional looking computer keyboard 1. However, each specific key cap has a designation made of transparent material with opaque material surrounding the designation in that key cap. The designation has indicia imprinted, painted or molded into the surface of the key cap which may be a number, a single letter of the alphabet or letters of the alphabet, an arrow, a word or an abbreviation of a word, a symbol or any combination of the same.

The particular indicia selected to be used for the designation on any key cap is conventional. For example, the designation on the key caps in the upper row 3 may consist of the letter and number combinations F1, F2 . . . F12 inclusive, Print Screen, Scroll Lock, and Pause Break. One such designation is associate with each such key cap, e.g., Print Screen is the designation on a separate key cap by itself.

The next row down 5, may have key caps with punctuation symbols, the individual numbers 1, 2 . . . , 9 and 0, mathematic functions, and an arrow. The row 7 immediately to the right of row 5 may have three key caps with instructions, like Insert, Home and Page Up. Further to the right of row 7 is row 9 which may have other number related function designations. Below rows 5, 7 and 9 is row 11 are key caps having tab arrows and the letters of the alphabet as arranged on a standard typewriter, i.e, Q, W, . . . O and P. Directly below row 11 are keyboard rows 13 and 15 each with individual covering key caps that each have other letters of the alphabet as arranged on a standard typewriter, i.e. A, S, D . . . J, K, L in row 13 and Z, X, C . . . B, N, M in row 15.

A caps lock key cap may appear in row 13 and two shift key caps, may be found in row 15 on opposite sides of the letters in that row. The lower row 17 may have may have several function key caps, and a large space bar key cap 19. To the right of row 11 are other function key caps 21 aligned in a row each with its own individual designation and an upstanding key cap. Below row 21 may be arrow keys 23 indicating the direction a cursor on the screen of the computer can be moved by depressing one of the keys.

The right most bank of keys 25 may consist of number integers (0-9, inclusive) and functions like, Number Lock, add, subtract, page down, etc. Thus, there is at least one indicia designation for each of the separate twenty six letters of the English alphabet and one separate key cap indicia designation for each of the integers 0 to 9 inclusive. It is important to note that the present invention does not dependent on the specific designation on the individual key cap or the arrangement of the different key caps. Any designation may be used for each of the individual key caps and the arrangement of the same key caps may vary as desired.

A housing 27 with appropriate spaced openings for the individual key caps to extend through contains the necessary electrical components and is connected by a cord 29 or it may be wireless to transmit the signals from the depressed keys to the computer's processor. This set up to input signals to the process is conventional.

At the right hand side of the housing is an added on/off switch 31 used to activate lighting internal of the housing 27 that will shine through the transparent designations or each of the individual keys and their key caps. The housing background facing or display surface 33 surrounding the openings used for the different rows and columns of key caps is preferably made of an opaque material as well as the sides and back of the housing. With this arrangement of key caps each with its own designation, only the transparent designations used for each of the individual key caps will have the light from the internal housing light source shining through them to an observer and user.

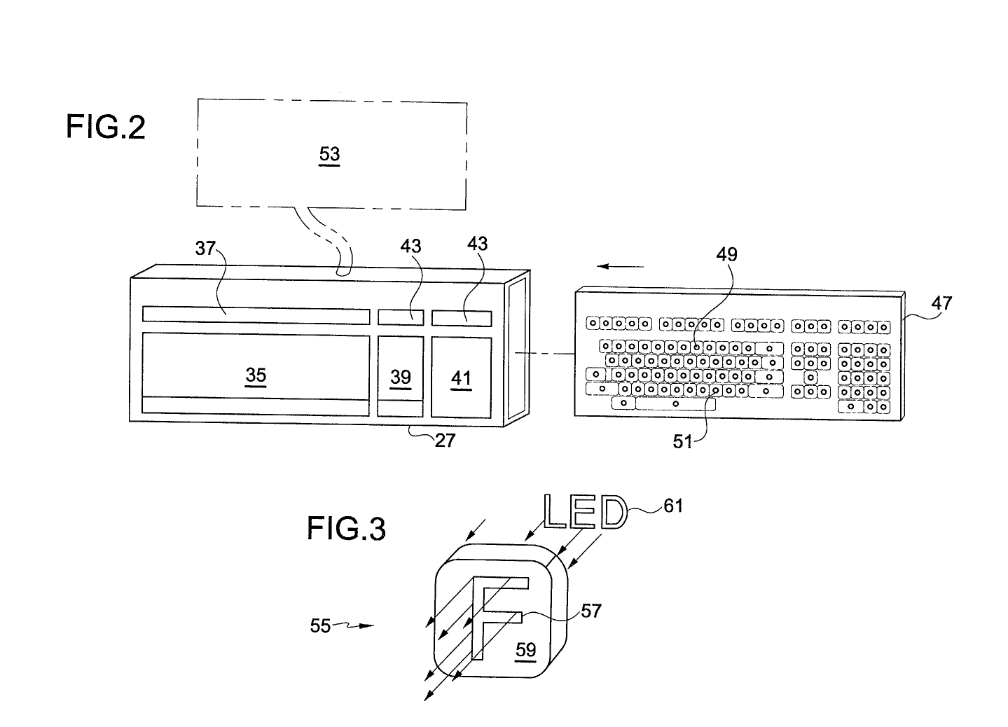

FIG. 2 is a perspective view of the underlying light source panel used with the keyboard of FIG. 1. Shown in dotted line format is the housing 27 with openings 35, 37,39, 41,43 and 45. The rows and columns of key caps shown in FIG. 1 would extend through these openings when the light source panel 47 is inserted into the housing 27, see arrow Specific key caps previously mentioned in FIG. 1 (not shown in FIG. 2 ) would extend from and through the openings as follows: those key caps in row 3 would extend through opening 37; those key caps in rows 5, 11, 13, 15 and 17 would extend through larger opening 35; those key caps in row 9 would extend through opening 43, those in rows 7, 21 and 23 would extend through opening 39; and those in panel 25 would extend through opening 41.

The flat sheet like panel 47 has Light Emitting Diodes (LED) 49 arranged and spaced such that one individual LED is directly behind a specific key cap . Thus each key cap shown in FIG. 1 have at least one of its own individual LED or it may more than one LED. For example, the relatively long spacing bar 19 of FIG. 1 could have have several separate aligned LED's 51 in the panel 47 that pass light through a transparent section of the key cap when the panel is inserted properly into the housing 27 will be directly behind and adjacent to the key cap making up the bar. Each key cap will have at least one LED light source associated with the key cap. Electric power for the LED's in the panel 47 may be supplied via the cord connection 29 to the computer processor 53 , shown in dotted, line format or it could be from a self contained power source like a battery. A key cap need not necessarily have a transparent indicia designation but it must have a light transparent section to allow light to be transmitted to a user, e.g., the space bar 19.

FIG. 3 is an enlarged perspective view of a typical key cap 55 schematically illustrating the transparent indicia designation material 57 of that key cap and the surrounding key cap opaque material 59. The LED light source 61 for this particular key cap is directly in back of the key cap and in the housing 27 on the inserted LED panel 47. Each key cap would have at least one such light source and large key caps with extensive designations could have more than one LED to shine light only though the transparent material making up the designation 57. The several arrows indicate the straight line direction light emitted from the LED would travel through the key cap indicia designation 57 to an observer and user. Clearly any of the conventional described letters, numbers or symbols or any combination of them could be the transparent indicia designation material 57 through which the light shines.

The material 59 in the key cap immediately surrounding the designation 57 is opaque and by its dark nature contrasts sharply with the light shining through making the shining designation stand out that much more. This allows for the use of the keyboard when there is little or no ambient light except for the computer screen and the LED keyboard light If desired, the light source may be shut off when not in use or when not necessary by actuating the switch 31 shown in FIG. 1. Different and colorful designs may be used on the housing and its key caps as desired. The material used to construct the present invention may be made from a variety of plastic material or other material to suit the needs and tastes of a user. A single large light source could possibly be used to illuminate all of the key caps, although using several small LED light sources is preferred to both save on energy costs and to more sharply direct or focus the emitted light from the individual sources to the transparent designated materials of each key cap.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. An illuminated keyboard comprising:
a housing for mounting a plurality of key caps;
each of said key caps having a segment made of transparent material and surrounding opaque material; and
a light source within said housing, said light source directing light through the indicia indicating designation of the key caps.

2. The illuminated keyboard as claimed in claim 1, wherein some of said plurality of key caps have indicia designations each of which is made substantially of transparent material.

3. The illuminated keyboard as claimed in claim 2, wherein light source comprises a light emitting diode.

4. The illuminated keyboard as claimed in claim 3, wherein the indicia designation of at least one key cap is composed at least partially of a letter.

5. The illuminated keyboard as claimed in claim 4, wherein each of said plurality of key caps has at least one light emitting diode source associated with the key cap and mounted in the housing adjacent the key cap.

6. The illuminated keyboard as claimed in claim 5, wherein housing is made of an opaque material.

7. The illuminated keyboard as claimed in claim 6, wherein the indicia designation on said key caps includes the twenty six letters of the alphabet and the integers 0 to 9 inclusive with one letter or integer being used for an indicia designation on a key cap.
